(19) United States
(12) Patent Application Publication
(10) Pub. No.: US 2010/0241529 A1
(43) Pub. Date: Sep. 23, 2010

(54) CONTENT TRANSACTION METHOD AND SYSTEM

(75) Inventor: Hyo Jin KIM, Daegu (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/702,448

(22) Filed: Feb. 9, 2010

(30) Foreign Application Priority Data
Mar. 17, 2009 (KR) 10-2009-0022641

(51) Int. Cl. G06Q 50/00; G06Q 30/00; G06Q 10/00; G06Q 99/00; G06Q 20/00; H04B 7/00

(52) U.S. Cl. 705/27; 705/30; 705/310; 455/41.2

(57) ABSTRACT

Content transaction method and system are disclosed. The method includes: searching, by a first mobile terminal, for at least one mobile terminal to perform a short-range wireless communication; performing, by the first mobile terminal, a connection with the searched at least one mobile terminal for the communication; receiving, by the first mobile terminal, a list of content for sale from the connected at least one mobile terminal; requesting. from a second mobile terminal storing content to sell, the content by the first mobile terminal; receiving, by the first mobile terminal, the requested content that is requested from the second mobile terminal; and accessing a payment server by the first mobile terminal and the second mobile terminal to transmit content transaction record information.

### CLAIM OF PRIORITY

This application claims, pursuant to 35 USC 119, priority to, and the benefit of the earlier filing date of, that patent application filed in the Korean Patent Office on Mar. 17, 2009, entitled “Content Transaction Method and System,”, and afforded serial number 10-2009-22641, the contents of which are incorporated by reference herein.

### BACKGROUND OF THE INVENTION

1. Field of the Invention

The present invention relates to the field of mobile terminals and more particularly, to a method of transacting content between mobile terminal users and a system for performing same.

2. Description of the Related Art

With recent rapid and widespread adoption of mobile terminals, these devices have become a modern necessity. The mobile terminals provide various data transmission services and various supplementary services in addition to voice communication services, such that mobile terminals have changed into multimedia communication devices in view of the multitude of functions that can be performed. As multimedia communication devices, the mobile terminal may function as a game player, a music player and a moving picture player and a user of the mobile terminal may receive variable content with respect to whether the content is “on-line” or “off-line.”

In order to receive content online, the user of the mobile terminal accesses to a content server and downloads desired content. For example, when the user wants to receive game content, for example, the user may access the contents server providing the game content, search for game content, and download the desired game content to the mobile terminal. The content server transmits the game content to the mobile terminal and adds a content charge to the call charge or the other payment methods may be impose in order to pay for the content.

However, when the user downloads content and keeps on using the content, the user loses an interest in the content and then rarely uses the content. When the user uses the downloaded content no longer, the content needlessly occupies capacity in a storage media of the mobile terminal. When the user downloads content but takes no interest in the content from the beginning, the user may waste undesired content charge(s). Since, according to the existing art, the mobile terminal receives data through a Wireless Application Protocol (WAP) from the content server when downloading the content, a data transmission charge is added to the content charge which imposes a cost burden on the user of the mobile terminal.

Therefore, the present invention proposes a method of purchasing content cheaper than purchasing content from a content server, of selling the content purchased from the content server to another mobile terminal, and a system for performing the same.

### SUMMARY OF THE INVENTION

The present invention provides a content transaction method of purchasing content cheaper than purchasing content from a content server.

The present invention also provides a content transaction method of selling purchased content to another mobile terminal.

The present invention further provides a content transaction method of receiving content without paying data transmission charge.

The present invention further provides a content transaction system for performing the content transaction method.

The present invention provides a content transaction method including: searching for at least one mobile terminal to perform a short-range wireless communication, by a first mobile terminal, performing a connection with the searched at least one mobile terminal for the communication with the first mobile terminal; receiving, by the first mobile terminal, a list of content for sale from the connected at least one mobile terminal; requesting a second mobile terminal storing content to sell the content from the first mobile terminal when the content is selected from the received list of content for sale; receiving the content that is requested to be sold from the second mobile terminal by the first mobile terminal; and accessing a payment server by the first mobile terminal and the second mobile terminal to transmit content transaction record information.

In accordance with an exemplary embodiment of the present invention, there is provided a content transaction method including: selecting content for sale by a first mobile terminal; searching for at least one mobile terminal to perform short-range wireless communication by the first mobile terminal; performing, by the first mobile terminal, connection with a second mobile terminal for communications, corresponding to one of the searched mobile terminals; transmitting, by the first mobile terminal, content selling information to the second mobile terminal; transmitting, by the first mobile terminal, content to the second mobile terminal when the second mobile terminal requests the selling content; and accessing a payment server, by the first mobile terminal and the second mobile terminal, to transmit content transaction record information.

In accordance with another exemplary embodiment of the present invention, there is provided a content transaction system, including: a first mobile terminal searching for at least one mobile terminal to perform short-range wireless communication, performing a connection with the searched at least one mobile terminal, receiving a list of content for sale from the connected at least one mobile terminal, requesting a second mobile terminal having content to sell the content when the content is selected from the received list of content for sale, receiving the content requested to be sold from the second mobile terminal, and accessing a payment server to transmit content transaction record information; the second mobile terminal transmitting the content to the first mobile terminal when the first mobile terminal requests the content, erasing the transmitted content from a storage medium, and accessing the payment server to transmit content transaction record information; wherein the payment server receiving the content transaction record information from the first mobile terminal and the second mobile terminal, imposes a content transaction price on the first mobile terminal, compensating in whole or in part the content transaction price to the second mobile terminal.

In accordance with another exemplary embodiment of the present invention, there is provided a content transaction system, including: a first mobile terminal searching for at least one mobile terminal to perform short-range wireless communication, performing connection with a second mobile terminal corresponding to the searched at least one mobile terminal, transmitting content selling information to the second mobile terminal, transmitting content to the second mobile terminal when a content selling request signal is received from the second mobile terminal, erasing the transmitted content from a storage medium, and accessing a payment server to transmit content transaction record information; the second mobile terminal receiving the content selling information from the first mobile terminal, transmitting the content selling request signal to the first mobile terminal, and accessing the payment server to transmit content transaction record information when the content is received from the first mobile terminal; and the payment server receiving the content transaction record information from the first mobile terminal and the second mobile terminal, imposing a content transaction price on the second mobile terminal, and compensating in whole or in part the content transaction price to the first mobile terminal.

In a feature of the present invention, a user may purchase content at a lower cost than the purchase of content from a content server. Moreover, a user may receive desired content without data transmission charge generated when downloading the content from a content server. A user resells the purchased content to another mobile terminal so as to reuse unnecessary content. Some of transaction cost is compensated to a content provider during the transaction of content so that payment of the content provider may be guaranteed.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a content transaction system according to an exemplary embodiment of the present invention;

FIG. 2 is a block diagram illustrating a mobile terminal employed in the content transaction system according to an exemplary embodiment of the present invention;

FIG. 3 is a sequence diagram illustrating a content transaction method according to an exemplary embodiment of the present invention;

FIG. 4 is a sequence diagram illustrating a content transaction method according to another exemplary embodiment of the present invention;

FIG. 5A shows a screen listing names of Bluetooth devices according to an exemplary embodiment of the present invention;

FIG. 5B shows a screen displayed when a menu icon is input on the screen of FIG. 5A according to an exemplary embodiment of the present invention;

FIGS. 6A and 6B are exemplary views illustrating lists of content for according to an exemplary embodiment of the present invention; and

FIGS. 7A to 7D are screens illustrating content lists according to an exemplary embodiment of the present invention.

### DETAILED DESCRIPTION OF THE INVENTION

A mobile terminal employed in an exemplary embodiment of the present invention may facilitate wireless communication with another mobile terminal and may access a web server or a WAP server via a wired line or a wireless line. In an exemplary embodiment of the present invention, a short-range wireless communication will be described as a wireless communication between mobile terminals. However, the present invention is not limited thereto and various communication methods which may communicate data by establishing a communication channel between the mobile terminals may be applied to the present invention. In the exemplary embodiment of the present invention, Bluetooth will be described as a short-range wireless communication method. However, the present invention is not limited thereto and Ultra wideband (UAB), Zigbee, and infrared communication (IrDA) may be applied to the short-range wireless communication of the present invention. The term ‘content’ used in the exemplary embodiments of the present invention described herein refers to digital content such as game content, music content, and moving picture content typically and includes all content received from the content server.

Exemplary embodiments of the present invention will be described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

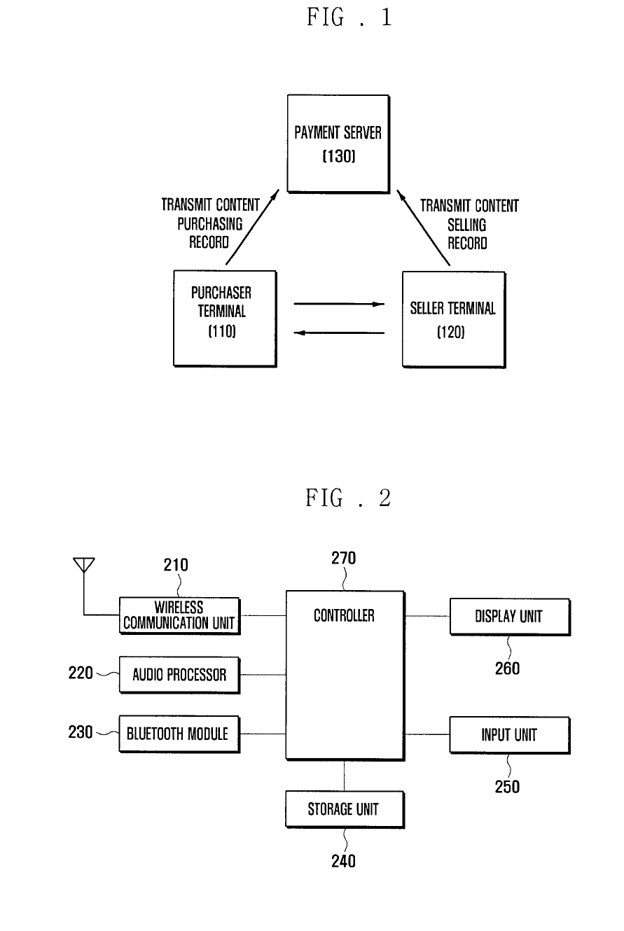

FIG. 1 shows a content transaction system according to an exemplary embodiment of the present invention.

The content transaction system according to an exemplary embodiment of the present invention includes a purchaser terminal 110, a seller terminal 120, and a payment server 130.

The purchaser terminal 110 receives content from the seller terminal 120. The purchaser terminal 110 searches for mobile terminals around the purchaser terminal 100 using, for example, a Bluetooth communication protocol. After the purchaser terminal 110 searches for the mobile terminals using the Bluetooth communication protocol, the purchaser terminal 110 requests the searched mobile terminals transmit a list of content for sale. The list of content for sale refers to a list of content at which a user registers content for sale. The mobile terminal includes a selling content registering menu and the user registers the content for resale among the content stored in the mobile terminal at the selling content registering menu. The purchaser terminal 110 receives the list of content for sale. When any content is selected by the user from a plurality of content included in the list of content for sale, the purchaser terminal 110 requests a mobile terminal having the selected content to sell the content. The mobile terminal, among the mobile terminals searched by the purchaser terminal 110, which receives a content selling request signal, serves as the seller terminal 120. The purchaser terminal 110 receives content data from the seller terminal 120 and accesses the payment server 130 to transmit content purchase record information to the payment server 130.

In another exemplary embodiment of the present invention, a purchaser terminal 110 receives content selling information from a seller terminal 120. When a user inputs a command for purchasing content, the purchaser terminal 110 transmits a content selling request signal to the seller terminal 120. The purchaser terminal 110 receives content data from the seller terminal 120 and accesses a payment server 130. The purchaser terminal 110 transmits content purchasing record information to the payment server 130.

In an exemplary embodiment of the present invention, a seller terminal 120 serves as a mobile terminal from which the purchaser terminal 110 requests the selling of content. In one aspect of the invention, the seller terminal 120 may prepare a list of content for sale in advance prior to the content selling request from the purchaser terminal 110. In another aspect of the invention, the list of content for sale may be prepared when the content selling request is received. The seller terminal 120 transmits the list of content for sale to the purchaser terminal 110 and transmits content data requested to be sold to the purchaser terminal 110 when the purchaser terminal 110 requests one or more of the content offered for sale. The seller terminal 120 erases the content data transmitted to the purchaser terminal 110 from a storage media of the seller terminal 120. The seller terminal 120 accesses the payment server 130 and transmits content selling record information thereto.

In another exemplary embodiment of the present invention, the seller terminal 120 searches for surrounding mobile terminals facilitating Bluetooth communication. The seller terminal 120 transmits content selling information to a purchaser terminal 110 selected from the searched mobile terminals. When the content selling request signal is received from the purchaser terminal 110, the seller terminal 120 transmits content data to the purchaser terminal 110. The seller terminal 120 then erases content data stored in a storage media. The seller terminal 120 accesses the payment server 130 and transmits content selling record information to the payment server 130.

In an exemplary embodiment of the present invention, a payment server 130 receives content selling records from a purchaser terminal 120 and subtracts a preset amount for the content sold from a communication fee of the purchaser terminal 110. The payment server 130 receives content purchasing record information from the purchaser terminal 110 and imposes the preset amount for purchasing content on on the purchaser terminal 110. In an exemplary embodiment of the present invention, the payment server 130 compensates a content provider for some of the sold content. The payment server 130 may also be compensated as commission on payment for some of the sold content. Although the payment server 130 has been described for imposing a content purchasing amount on the purchaser terminal 110 or discounting a content selling amount on the entire communication fee of the seller terminal 120, the present invention is not limited thereto but every type of money or credit or other measurable asset (for example, points) used in a digital content transaction system may be a payment method.

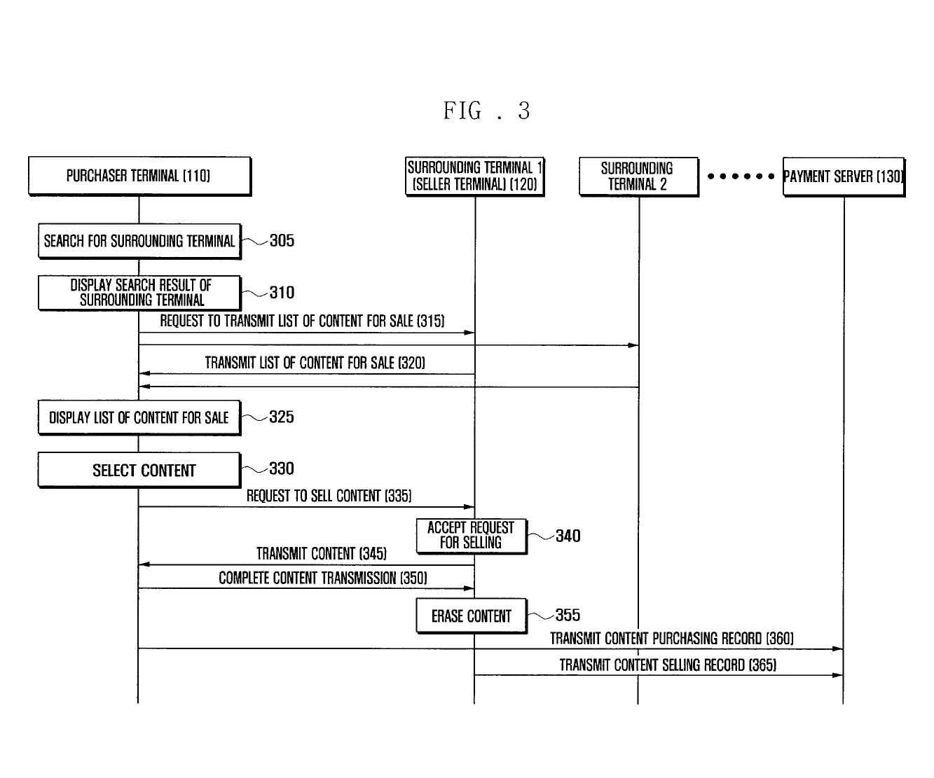

FIG. 2 is a block diagram illustrating a mobile terminal employed in the content transaction system according to an exemplary embodiment of the present invention.

A mobile terminal according to an exemplary embodiment of the present invention includes a wireless communication unit 210, an audio processor 220, a Bluetooth module 230, a storage unit 240, an input unit 250, a display unit 260, and a controller 270.

The wireless communication unit 210 performs transmission/reception of data for wireless communication of the mobile terminal. The wireless communication unit 210 may include an RF transmitter that up-converts and amplifies a frequency of a signal to be transmitted and an RF receiver that low-noise amplifies a received signal and down-converts the signal. The wireless communication unit 210 receives data through a wireless channel and outputs the received data to the controller 270, and outputs data output from the controller 270 through the wireless channel. In this exemplary embodiment of the present invention, the wireless communication unit 210 accesses the payment server 130 through an information communication network (e.g., a wireless application protocol (WAP) to be accessed via a wireless line and Internet network using TCP/IP to be accessed via a wired line). In the purchaser terminal 110, the wireless communication unit 210 transmits user identification information, device identification information, and a password to the payment server 130 under the control of the controller 270, and accesses the payment server 130 to transmit content purchasing record information by receiving approval from the payment server 130. In the seller terminal 120, the wireless communication unit 210 accesses the payment server 130 to transmit content selling record information under the control of the controller 270.

The audio processor 230 may include a CODEC wherein the CODEC may include a data CODEC processing packet data and an audio CODEC processing an audio signal, such as a voice signal. The audio processor 230 converts a digital audio signal into an analog audio signal using the audio CODEC to reproduce the audio signal through a speaker SPK, and converts an analog audio signal input from a microphone MIC into a digital audio signal using the audio CODEC. In the exemplary embodiment of the present invention, the audio processor 230 may output an effect sound corresponding to every state of the content transaction as it is performed between the mobile terminals. For example, when the purchaser terminal 110 receives a list of content for sale from the seller terminal 120, when the purchaser terminal 110 completes the reception of content data from the seller terminal 120, and when the purchaser terminal 110 accesses the payment server 130, the audio processor 230 may output an effect sound corresponding to the step of the transactions. The audio processor 230 of the seller terminal 120 may output effect sounds corresponding to steps of the transaction when a list of content for sale or content data are transmitted to the purchaser terminal 110 or when accessing the payment server 130.

The Bluetooth module 230 transmits and receives voice and data signals to and from devices capable of performing Bluetooth communication through a wireless interface within the range of the mobile module. A mobile terminal corresponds to a master device. The Bluetooth module 230 transmits an inquiry signal and a page signal to surrounding devices under the control of the controller 270. In an exemplary embodiment of the present invention, the purchaser terminal 110 serves as a master device. In another exemplary embodiment of the present invention, the seller terminal 120 serves as a master device. The inquiry signal and the page signal include device address information BD_ADDR and clock information and are transmitted in ID packet form. When a mobile terminal serves as a slave device, the Bluetooth module 230 performs inquiry scan or page scan under the control of the controller 270. In one aspect of the invention, the seller terminal 120 may serve as a slave device in an exemplary embodiment of the present invention, and in another aspect of the invention, the purchaser terminal 110 may serve as a slave device. The Bluetooth module 230 in the inquiry scan state scans an inquiry signal transmitted from a master device and transmits an inquiry response signal to the master device when the inquiry signal is received. The Bluetooth module 230 in the page scan state scans a page signal transmitted from a master device and transmits a page response signal to the master device when the page signal is received. In an exemplary embodiment of the present invention, the Bluetooth module 230 of the purchaser terminal 110 performs paging and connection with inquired mobile terminals sequentially to receive a list of content for sale from respective connected mobile terminals, under the control of the controller 270. In an exemplary embodiment of the present invention, the Bluetooth module 230 may release the connection with the mobile terminal after the reception of a list of content for sale. In an exemplary embodiment of the present invention, a Bluetooth module 230 of the seller terminal 120 performs inquiry scan and page scan and performs connection with the purchaser terminal 110 to transmit content data to the purchaser terminal 110. In another exemplary embodiment of the present invention, a Bluetooth module 230 of the seller terminal 120 performs paging and connection with a mobile terminal selected from the inquired mobile terminals by a user and transmits content selling information to the connected mobile terminal. In another exemplary embodiment of the present invention, a Bluetooth module 230 of the purchaser terminal 110 receives content data from a Bluetooth module 230 of the seller terminal 120.

The storage unit 240 stores a program and data required to operate a mobile terminal. In an exemplary embodiment of the present invention, the storage unit 240 stores a list of content for sale. The mobile terminal includes a selling content registering menu and a user may select content for sale from the content stored in the storage unit 240 to register the selected content on the list of content for sale. The storage unit 240 of the purchaser terminal 110 stores content data transmitted from the seller terminal 120.

The input unit 250 receives a key manipulation signal for controlling the mobile terminal from a user and transmits the same to the controller 270. The input unit 250 may include a keypad having number keys and arrow keys or a touch pad when the mobile terminal includes a touch screen. When a mobile terminal includes an image sensor and an acceleration sensor, the sensors may serve as the input unit 250. In an exemplary embodiment of the present invention, a user may set a list of content for sale through the input unit 250. Moreover, a user may search for a surrounding mobile terminal performing Bluetooth communication and may select content to purchase or sell.

The display unit 260 may include a liquid crystal display (LCD) and visually provides a menu of a mobile terminal, input data, function setting information, and other information to a user. For example, the display unit 260 outputs a booting screen, a standby screen, a displaying screen, a calling screen, and an application execution screen of a mobile terminal. In an exemplary embodiment of the present invention, a display unit 260 of the purchaser terminal 110 displays information on at least one searched mobile terminal (for example, address (BD_ADDR) and name of a Bluetooth device). In an exemplary embodiment of the present invention, the display unit 260 of the purchaser terminal 110 displays a list of content for sale received from at least one searched mobile terminal. In another exemplary embodiment of the present invention, a display unit 260 of the purchaser terminal 110 displays content selling information received from the seller terminal 120.

The controller 270 controls overall operation of respective elements of a corresponding mobile terminal. In an exemplary embodiment of the present invention, a controller of the purchaser terminal 110 controls the Bluetooth module 230 to broadcast an inquiry signal. The controller 270 controls the Bluetooth module 230 to receive an inquiry response signal from at least one surrounding mobile terminal. The controller 270 controls the Bluetooth module 230 to perform paging and connection with mobile terminals which receive the inquiry response signal. The controller 270 controls the Bluetooth module 230 to receive lists of content for sale from the connected mobile terminals. The controller 270 controls the Bluetooth module 230 to transmit a content selling request message to a mobile terminal having content selected by a user. In an exemplary embodiment of the present invention, when a plurality of mobile terminals has the content selected by a user, the controller 270 selects one of the mobile terminals. The controller 270 may select a mobile terminal based on a transmission order of the list of content for sale or price information associate with the content. The controller 270 controls the Bluetooth module 230 to receive content data from the seller terminal 120. The controller 270 controls the wireless communication unit 210 to access to the payment server 130 and transmits content purchasing record information.

In an exemplary embodiment of the present invention, a controller 270 of the seller terminal 120 controls the Bluetooth module 230 to perform inquiry scan or page scan. An inquiry signal is received from the purchaser terminal 110, the controller 270 controls the Bluetooth module 230 to transmit an inquiry response signal or a page response signal to the purchaser terminal 110. The controller 270 controls the Bluetooth module 230 to perform a connection with the purchaser terminal 110. When the purchaser terminal 110 requests to content offered for sale, the controller 270 controls the Bluetooth module 230 to transmit content data to the purchaser terminal 110. The controller 270 then erases the content data stored in the storage unit 240. The controller 270 controls the wireless communication unit 210 to access the payment server 130 and transmits content selling record information.

In another exemplary embodiment of the present invention, a controller 270 of the seller terminal 120 controls the Bluetooth module 230 to broadcast an inquiry signal. The controller 270 controls the Bluetooth module 230 to receive an inquiry response signal from at least one surrounding mobile terminal. When any one of the mobile terminals transmitting the inquiry response signal is selected by a user, the controller 270 controls the Bluetooth module 230 to perform paging and connection with the selected mobile terminal. The controller 270 controls the Bluetooth module 230 to transmit content selling information to the selected mobile terminal. A content selling request message is received from the selected mobile terminal, the controller 270 controls the Bluetooth module 230 to transmit content data to the purchaser terminal 110. The controller 270 then erases the transmitted content data from the storage unit 240. The controller 270 controls the wireless communication unit 210 to access the payment server 130 and transmits content selling record information.

In another exemplary embodiment of the present invention, a controller 270 of the purchaser terminal 110 controls the Bluetooth module 230 to perform an inquiry scan or page scan. When an inquiry signal is received from the seller terminal 120, the controller 270 controls the Bluetooth module 230 to transmit an inquiry response signal or a page response signal to the seller terminal 120. The controller 270 controls the Bluetooth module 230 to perform a connection with the seller terminal 120. The controller 270 controls the Bluetooth module 230 to receive content data from the seller terminal 120. The controller 270 controls the wireless communication unit 210 to access the payment server 130 and transmits content purchasing record information.

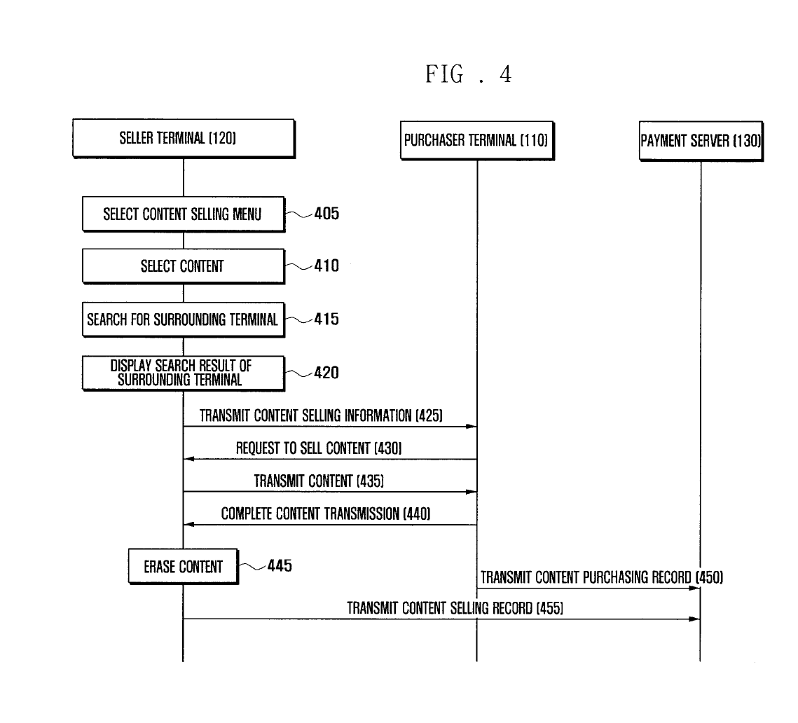

FIG. 3 is a sequence diagram illustrating a content transaction method according to an exemplary embodiment of the present invention. Hereinafter, the content transaction method will be described based on the purchaser terminal 110, the seller terminal 120, and the payment server 130, and description of elements of the respective mobile terminals that have previously been described need not be provided again.

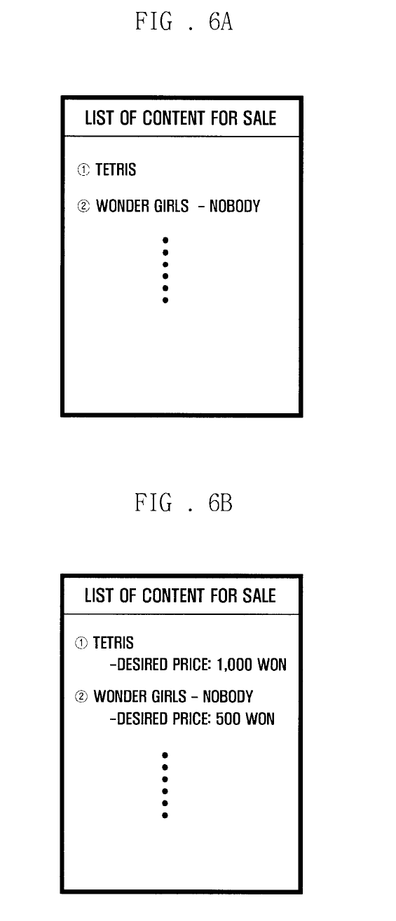

The purchaser terminal 110 searches for a surrounding mobile terminal (hereinafter, referred to ‘surrounding terminal’) capable of performing Bluetooth communication (305). In order to search for the surrounding terminal, the purchaser terminal 110 broadcasts an inquiry signal and surrounding terminals receive the inquiry signal from the purchaser terminal 110 in an inquiry scan state. The surrounding terminals transmit an inquiry response signal to the purchaser terminal 110. The inquiry response signal includes Bluetooth device address information BD_ADDR and clock information of the surrounding terminals. The purchaser terminal 110 may the request the respective surrounding terminals transmit name a of the corresponding Bluetooth device after the reception of the inquiry response signal. The surrounding terminals transmit the name of Bluetooth device to the purchaser terminal 110 and the purchaser terminal 110 receives the name of Bluetooth device and displays the received name of Bluetooth device on a screen (310). FIG. 5A shows a screen listing names of Bluetooth devices and icons indicating kinds of Bluetooth device, names of the Bluetooth devices ‘SCH-W330 (52**), SPH-B5600 (71**)’, and menu icons.

The purchaser terminal 110 requests the respective surrounding terminals to transmit a list of content for sale (315). The purchaser terminal 110 performs paging and connection with the searched surrounding terminals. The purchaser terminal 110 sequentially performs paging and connection with a plurality of surrounding terminals and requests the connected surrounding terminals transmit a list of content for sale. In an exemplary embodiment of the present invention, when the purchaser terminal 110 and the surrounding terminals are connected to each other, the respective terminals may set a link key using a pin code input by a user and may perform the connection. FIG. 5B shows a screen displayed when a menu icon is input from the screen of FIG. 5A. FIG. 5B shows a list of Bluetooth function menus, such as ‘connection’, ‘service list’, ‘delete’, and ‘list of content for sale’. A user of the purchaser terminal 110 selects a menu of ‘list of content for sale’ (as indicated by cross-hatching) from the list of Bluetooth function menus and requests the connected surrounding terminals transmit the list of content for sale.

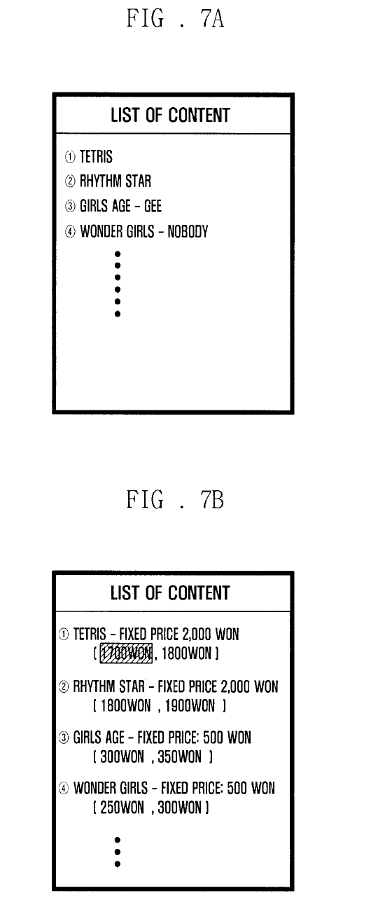

The list of content for sale refers to a content list that a user of a mobile terminal registered in a selling content list registering menu, wherein the user selects content from content stored in a storage media of a mobile terminal to register the selected content in the list of content for sale. FIGS. 6A and 6B are exemplary views illustrating a list of content for sale. As illustrated in FIG. 6A, \textcircled{1} refers to game content of ‘Tetris’ and \textcircled{2} refers to moving picture content of ‘wonder girls—Nobody’ as listed. A user may select \textcircled{1} and/or \textcircled{2} from content stored in the storage media of the mobile terminal and registers the selected content in the list of content for sale. In an exemplary embodiment of the present invention, the user of a mobile terminal sets ‘desired price’ on content to be registered in the list of content for sale. FIG. 6B shows the list of content for sale in which the ‘desired price’ is set. When a mobile terminal user wants to sell Tetris, for example, that has been purchased at 2,000 Won from the content server, for 1,000 Won, the user may set and register the ‘desired price’ of Tetris content to ‘1,000 Won’ in the list of content for sale. In an exemplary embodiment of the present invention, a threshold of the ‘desired price’ may be set. The transaction price may be determined higher than a preset price or a preset ratio of content price so that the content provider may be compensated with a preset amount of the content transaction price. In one aspect of the invention, the selling content list registering menu is registered on all mobile terminals searched by the purchaser terminal 110 at least one content is registered in the list of content for sale.

The surrounding terminals respond to the request for transmission of the list of content for sale from the purchaser terminal 110 and transmit the list of content for sale to the purchaser terminal 110 (320). When users of the surrounding terminals want to sell the content included in the list of content for sale, the users input ‘YES’ in response to a message for requesting transmission of the list of content for sale from the purchaser terminal 110. In this case, the surrounding terminals transmit lists of content for sale to the purchaser terminal 110.

When the list of content for sale is received, the purchaser terminal 110 releases the connection with the surrounding terminals. In an exemplary embodiment of the present invention, the purchaser terminal 110 establishes a piconet even after the reception of the lists of content for sale from the surrounding terminals to maintain the connection with the surrounding terminals. That is, the purchaser terminal 110 sequentially performs the connection with the surrounding terminals, releases the connection with the surrounding terminal which has transmitted the corresponding list of content for sale when the list of content for sale is received, and maintains the connection with the surrounding terminals even after the reception of the lists of content for sale. Next, the purchaser terminal 110 displays the list of content for sale on a screen (325). In an exemplary embodiment of the present invention, the purchaser terminal 110 may display the list of content for sale received from the respective surrounding terminals according to names of content.

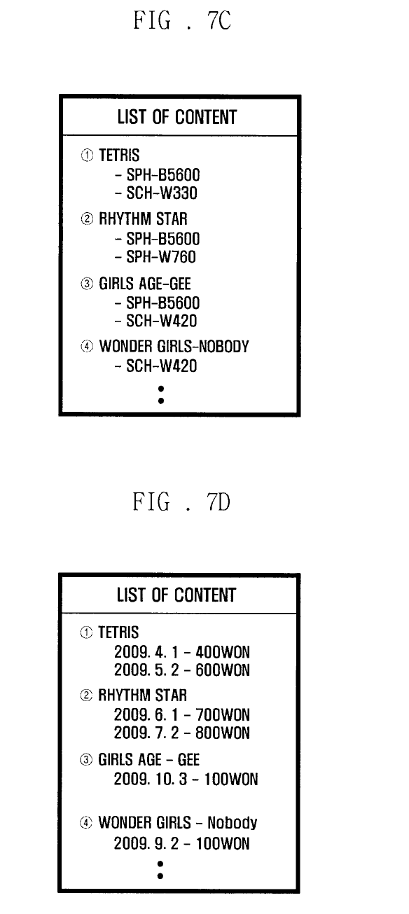

FIGS. 7A to 7D are screens illustrating content lists according to an exemplary embodiment of the present invention. FIG. 7A shows a screen on which only the name of content is displayed. The purchaser terminal 110 displays duplicate content only once when the duplicate content is found in the lists of content for sale received from the respective surrounding terminal. In other words, when a first surrounding terminal and a second surrounding terminal transmit lists of content for sale include ‘Tetris’ content to the purchaser terminal 110, the purchaser terminal 110 displays ‘Tetris’ on a list of content only once. In another aspect, the purchaser terminal 110 may display the content name repeatedly. For example, when the list of content for sale is received from the first surrounding terminal and the second surrounding terminal, the purchaser terminal 110 may display the received lists of content for sale sequentially. In this case, when identical content is included in the first and second surrounding terminals, the purchaser terminal 110 may display the identical content repeatedly. In an exemplary embodiment of the present invention, the purchaser terminal 110 may display the content name by adding content price information thereto. FIG. 7B shows a screen on which a list content added with a ‘desired price’ is displayed. When the ‘desired price’ is set to the list of content for sale registered to the surrounding terminals, the purchaser terminal 110 displays the ‘desired price’ with the content names. In an exemplary embodiment of the present invention, the purchaser terminal 110 may display content price (i.e., a fixed price) from the content server together with the content name. A user of the purchaser terminal 110 compares the displayed content price with the desired price so that desired content may be purchased at lower price.

FIG. 7C shows a screen on which a content name and device names of the surrounding terminals having the corresponding content are displayed. The purchaser terminal 110 matches the content name to the device names of the surrounding terminals having the content to display so that a user of the purchaser terminal 110 may select a specific mobile terminal and may receive content data therefrom. FIG. 7D shows a list of content when a remaining license for use is available. The term “remaining license for use” refers to a remaining period for use or a remaining number of times for use of the content in which period for use or number of times for use is restricted. In an exemplary embodiment of the present invention, the seller terminal 120 may sell the remaining license for use to the purchaser terminal 110 to succeed the remaining license for the user. For example, when a mobile terminal user purchases content for twenty times, uses the content eleven times, and wants to sell the content, the seller terminal 120 may sell the content having remaining license, for nine uses, to the purchaser terminal 110 or may sell content having remaining license of twenty times use.

When the seller terminal 120 sells the remaining license to the purchaser terminal 110 with succession, price of the content may be settled according to the remaining period for use or the remaining times for use. When content prices corresponding to remaining period for user or remaining times for use are set to respective content, the purchaser terminal 110 displays the list of content with the content name, the remaining times for user or the remaining period for user, and the content price. Referring to FIG. 7D, an item ‘Tetris Apr. 1, 2009-400 Won’ indicates that the item is content of the game ‘Tetris’ to use until Apr. 1, 2009 and the price is 400 Won. The content price may be determined by a user or by a preset price according to the remaining times for user or the remaining period for user.

The purchaser terminal 110 selects any content from the displayed list of content (330). When the lists of content for sale received from the surrounding terminals include content that a user of the purchaser terminal 110 wants to purchase, the input unit of the purchaser terminal 110 selects the content.

The purchaser terminal 110 transmits a signal requesting the surrounding terminal having the selected content to sell the selected content (335). Referring to FIG. 7A, when a user selects ‘Tetris’ from the displayed lists of content, the purchaser terminal 110 transmits a content selling request signal to one of the surrounding terminals having ‘Tetris’. The purchaser terminal 110 may select a surrounding terminal which transmitted the list of content for sale from the surrounding terminals having ‘Tetris’, or may select a surrounding terminal proposing the lowest ‘desired price’ when the ‘desired price’ is presented. As illustrated in FIG. 7B, a ‘desired price’ displayed together with the list of content, a user may select a ‘desired price’ and the purchaser terminal 110 transmits a content selling request signal to a surrounding terminal to sell the content at the ‘desired price’. As illustrated in FIG. 7C, when device names of the surrounding terminals are displayed with the list of content, a user may select a specific terminal and the purchaser terminal 110 transmits the content selling request signal to the selected specific terminal. As illustrated in FIG. 7D, when the remaining license for use is display in the list of content, a user may select the remaining license for use and the purchaser terminal 110 transmits the content selling request signal to a surrounding terminal corresponding to the selected remaining license for use.

The surrounding terminal that receives the content selling request signal from the purchaser terminal 110 serves as the seller terminal 120. The purchaser terminal 110 may transmit the content selling request signal to the seller terminal 120 without performing the connection with the seller terminal 120 when the connection with the seller terminal 120 is maintained. However, the purchaser terminal 110 transmits the content selling request signal to the seller terminal 120 after the performance of the connection with the seller terminal 120 when the connection with the seller terminal 120 had been released. Since the purchaser terminal 110 and the seller terminal 120 have established a communication channel for the transmission and reception of the list of content for sale, the communication channel is rapidly established for the reconnection therebetween.

When a user of the seller terminal 120 accepts the content selling request (340), the seller terminal 120 transmits the selected content data to the purchaser terminal 110 (345). The purchaser terminal 110 receives the content data (350). In an exemplary embodiment of the present invention, the content data may include information such as a content identification (ID), a content name, a remaining license for use, a data size, and address of a payment server. After reception of the content data, the purchaser terminal 110 transmits a message of correctly receiving the content to the seller terminal 120. The seller terminal 120 then erases the stored content data (355) after the reception of the message of correctly receiving the content from the purchaser terminal 110. When the seller terminal 120 fails to transmit the content data to the purchaser terminal 110, the seller terminal 120 displays a message ‘fail to transmit content data’ on its screen and the purchaser terminal 110 displays a message ‘fail to receive content data’ on its screen. In this case, the seller terminal 120 does not erase the content data from the storage media. In this case, the seller terminal 120 may continue to transmit the content data to the purchaser terminal again. In an exemplary embodiment of the present invention, when N times of retransmission is set and the seller terminal 120 tries and fails to transmit the content data in more than N attempts, the seller terminal 120 and the purchaser terminal 110 may break the data transmission and reception communication link. In this case, the content data remains stored in the seller terminal 120.

The purchaser terminal 110 accesses the payment server 130 and transmits content purchasing record information (360). The seller terminal 120 accesses the payment server 130 and transmits content selling record information (365). The purchaser terminal 110 and the seller terminal 120 may access the payment server 130 simultaneously or sequentially. The purchaser terminal 110 and the seller terminal 120 try to access the payment server 130 using an address of the payment server 130 included in the content data. The payment server 130 includes a user information database. When the purchaser terminal 110 or the seller terminal 120 accesses the payment server 130, the payment server 130 compares an identification (ID, e.g., a telephone number) of the purchaser terminal 110 or the seller terminal 120 with the user information database and determines whether access to the payment server 130 is allowed. After accessing the payment server 130 the purchaser terminal 110 provides content purchasing record information, including a seller identification (seller ID), a content identification (ID), content price, and a remaining license for use, to the payment server 130. The seller terminal 120 accesses the payment server 130 and provides content selling record information, including a purchaser identification (purchaser ID), a content identification (content ID), content price, and a remaining license for use, to the payment server 130.

The payment server 130 receives the content purchasing record information from the purchaser terminal 110 and imposes the content price on the purchaser terminal 110. The payment server 130 receives the content selling record information from the seller terminal 120 and subtracts an amount associated with the content price from the seller terminal 120. In an exemplary embodiment of the present invention, the payment server 130 may compensate another portion of the content price to the content provider. The payment server 130 may check the content provider using the content ID received from the purchaser terminal 110 or the seller terminal 120. The payment server 130 compensates a preset amount of the content price to the checked content provider. The payment server 130 may be compensated with another amount of the content price as a commission for performing the payment operation. For example, when the purchaser terminal 110 purchases MP3 content for 450 Won from the seller terminal 120, the payment server 130 imposes a 450 Won fee as the content price on the purchaser terminal 110. The payment server 130 may subtract 200 Won of the content price 450 won from seller terminal 120. The payment server 130 compensates 200 Won of the remaining 250 Won to the content provider and may be compensated with 50 Won as commission on payment.

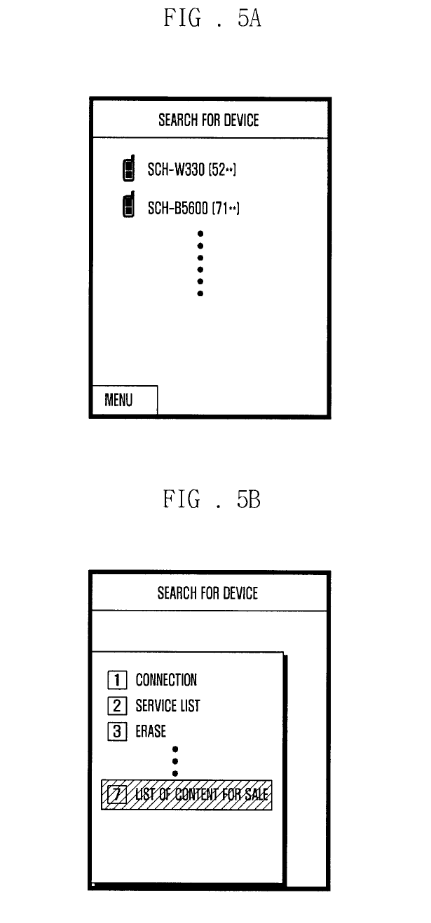

FIG. 4 is a sequence diagram illustrating a content transaction method according to another exemplary embodiment of the present invention.

A user of the seller terminal 120 selects a content selling menu (405). Menus of a mobile terminal include the content selling menu and a user selects the content selling menu when the user wants to sell the whole or a portion of the content stored in the storage unit 240. When a user selects the content selling menu, the seller terminal 120 displays a list of content stored in the storage unit 240. When a user selects one or more content from the displayed list of content (410), the seller terminal 120 broadcasts an inquiry signal and searches for mobile terminals positioned around the seller terminal 120 to perform Bluetooth communication (surrounding terminals) (415). The seller terminal 120 receives inquiry response signals from the surrounding terminals to acquire Bluetooth device addresses BD_ADDR of the surrounding terminals. The seller terminal 120 requests the surrounding terminals, which transmitted the inquiry response signals, to transmit device names and displays the search results of the surrounding terminals when the device names are received from the surrounding terminals (420).

The seller terminal 120 transmits content selling information to the purchaser terminal(s) 110 (425). In an exemplary embodiment of the present invention, the content selling information may include a content name, a desired price of content, a remaining license for use, and other content information (capacity, running time, sound quality of content). Firstly, the seller terminal 120 performs paging and connection with the purchaser terminal 110 and transmits the content selling information to the purchaser terminal 110 through a communication channel established after the connection. The purchaser terminal 110 transmits a content selling request signal to the seller terminal 120 through the established communication channel (430). The seller terminal 120 transmits corresponding content data to the purchaser terminal 110 (435) when the content selling request signal is received from the purchaser terminal 110. The purchaser terminal 110 transmits a message of “completely receiving content” to the seller terminal 120 (440). When the message of completely receiving content is received from the purchaser terminal 110, the seller terminal 120 then erases the content data transmitted to the purchaser terminal 110 from the storage media. The purchaser terminal 110 accesses the payment server 130 and transmits the content purchasing record information (450). The seller terminal 120 also accesses the payment server 130 and transmits the content selling record information to the payment server 130 (455). The purchaser terminal 110 and the seller terminal 120 may access the payment server 130 simultaneously or sequentially.

The payment server 130 imposes the content price on the purchaser terminal 110 after the reception of the content purchasing record information from the purchaser terminal 110. After the reception of the content selling record information from the seller terminal 120, the payment server 130 subtracts an amount of the content price from purchaser terminal 110. In an exemplary embodiment of the present invention, the payment server 130 compensates another amount of the content price to the content provider. The payment server 130 may be compensated with another amount of the content price as commission for performing the payment operation.

According to the present invention, since content data are transmitted and received using short-range communication between mobile terminals and transaction record information is transmitted by accessing a payment server, the content data may be acquired without a data communication fee. Since time to access the payment server is short the fee for using data is decreased.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A content transaction method comprising:
searching, by a first mobile terminal, for at least one mobile terminal to perform a short-range wireless communication;
performing a connection with the searched at least one mobile terminal for communication by the first mobile terminal;
receiving, by the first mobile terminal, a list of content for sale from the connected at least one mobile terminal;
requesting, from a second mobile terminal storing content to sell, the content when the content is selected by the first mobile terminal from the received list of content for sale;
receiving the content that is requested to sell from the second mobile terminal by the first mobile terminal; and
accessing a payment server by the first mobile terminal and the second mobile terminal to transmit content transaction record information.

2. The content transaction method of claim 1, wherein the content transaction record information comprises at least one of: a seller identification information, a purchaser identification information, a content identification information, a content price information, and a remaining license for use.

3. The content transaction method of claim 1, further comprising: erasing the content transmitted to the first mobile terminal from a storage medium of the second mobile terminal by the second mobile terminal.

4. The content transaction method of claim 1, further comprising: compensating, by the payment server, a preset amount of a content price to a content provider.

5. The content transaction method of claim 1, wherein, in the reception of the list of content for sale, the first mobile terminal receives the list of content for sale from the searched at least one mobile terminal sequentially, and disconnects from the mobile terminal which transmitted the list of content for sale when the list of content for sale is received.

6. The content transaction method of claim 1, wherein the list of content for sale comprises at least one of: a content name, price information of the content, terminal information, and a remaining license for use

7. A content transaction method comprising:
selecting content for sale by a first mobile terminal;
searching for at least one mobile terminal to perform short-range wireless communication by the first mobile terminal;
performing, by the first mobile terminal, a communications connection with a second mobile terminal, corresponding to one of the searched mobile terminals;
transmitting, by the first mobile terminal, content selling information to the second mobile terminal;
transmitting, by the first mobile terminal, content to the second mobile terminal when the second mobile terminal requests the content; and
accessing a payment server, by the first mobile terminal and the second mobile terminal, to transmit content transaction record information.

8. The content transaction method of claim 7, further comprising erasing, by the first mobile terminal, the content transmitted to the second mobile terminal from a storage medium of the first mobile terminal.

9. The content transaction method of claim 7, wherein the content transaction record information comprises at least one of: a seller identification information, a purchaser identification information, a content identification information, a content price information, and a remaining license for use.

10. The content transaction method of claim 7, further comprising compensating, by the payment server, a preset amount of a price of the content sold to the second mobile terminal to a content provider.

11. The content transaction method of claim 7, wherein the content selling information comprises at least one of: a content name, a content price, and a remaining license for use.

12. A content transaction system comprising:
a first mobile terminal:
searching for at least one mobile terminal to perform short-range wireless communication,
performing connection with the searched at least one mobile terminal,
receiving a list of content for sale from the connected at least one mobile terminal,
requesting, from a second mobile terminal having content to sell, the content when the content is selected from the received list of content for sale,
receiving the content requested from the second mobile terminal, and
accessing a payment server to transmit content transaction record information;
the second mobile terminal transmitting the requested content to the first mobile terminal, erasing the transmitted content from a storage medium, and accessing the payment server to transmit content transaction record information; and
the payment server receiving the content transaction record information from the first mobile terminal and the second mobile terminal, imposing a content transaction price on the first mobile terminal, and compensating in whole or part the content transaction price to the second mobile terminal.

13. The content transaction system of claim 12, wherein the content transaction record information comprises at least one of: a seller identification information, a seller identification information, a content identification information, a content price information, and a remaining license for use.

14. A content transaction system comprising:
a first mobile terminal searching for at least one mobile terminal to perform short-range wireless communication, performing a connection with a second mobile terminal corresponding to the at least one searched mobile terminal, transmitting content selling information to the second mobile terminal, transmitting content to the second mobile terminal when a content selling request signal is received from the second mobile terminal, erasing the transmitted content from a storage medium, and accessing a payment server to transmit content transaction record information;
the second mobile terminal receiving the content selling information from the first mobile terminal, transmitting the content selling request signal to the first mobile terminal, and accessing the payment server to transmit content transaction record information when the content is received from the first mobile terminal; and
the payment server receiving the content transaction record information from the first mobile terminal and the second mobile terminal, imposing a content transaction price on the second mobile terminal, and compensating in whole or part the content transaction price to the first mobile terminal.

15. The content transaction system of claim 14, wherein the content transaction record information comprises at least one of: a seller identification information, a purchaser identification information, a content identification information, a content price information, and a remaining license for user.

16. A mobile terminal comprising:
a short-range communication transceiving system; and
a processor in communication with a memory, the memory including code, which when accessed by the processor causes the processor to:
search for at least one mobile terminal within a known range of the mobile terminal;
receive a list of content for sale from selected ones of the at least one mobile terminal within a known range of the mobile terminal;
select at least one content from the received list of content;
transmit a request for the selected content; and
receive the selected content.

17. The mobile terminal of claim 16 further comprising:
a display for displaying the received list of content from the selected ones of the mobile terminals within a known range of the mobile terminal.

18. The mobile terminal of claim 16, further comprising:
an input device for selecting the content from the list of content.

19. The mobile terminal of claim 16, the processor further transmitting a content transaction record information.

20. The mobile terminal of claim 16, wherein the content transaction record information comprises at least one of: a seller identification information, a purchaser identification information, a content identification information, a content price information, and a remaining license for user.
